(19) United States
(12) Patent Application Publication
(10) Pub. No.: US 2026/0049710 A1
(43) Pub. Date: Feb. 19, 2026

(54) MICROPHONE

(71) Applicant: PANASONIC HOLDINGS CORPORATION, Osaka (JP)

(72) Inventors: Risako TSUJIMURA, Kanagawa (JP); Toshiyuki Matsumura, Osaka (JP); Kentaro Nakamura, Tokyo (JP); Zijian Wang, Tokyo (JP)

(21) Appl. No.: 19/368,181

(22) Filed: Oct. 24, 2025

Related U.S. Application Data
(63) Continuation of application No. PCT/JP2024/014755, filed on Apr. 11, 2024.

(30) Foreign Application Priority Data
Apr. 27, 2023 (JP) 2023-073583

(51) Int. Cl. F21V 33/00; F21Y 115/10; G02B 6/293; G02B 6/32; H04R 1/02

(52) U.S. Cl. CPC F21V 33/0056; G02B 6/2938; G02B 6/32; H04R 1/028; F21Y 2115/10

(57) ABSTRACT

A microphone 1 includes a light source 11 that outputs an optical signal, an optical coupler 12 that demultiplexes and multiplexes the optical signal, a transmission path 13 including an optical fiber 130 that transmits a demultiplexed optical signal demultiplexed by the optical coupler 12 to the optical coupler 12 in mutually opposite directions, a sensor part 14 that is connected to the transmission path 13 and returns the demultiplexed optical signal to be transmitted by the transmission path 13 to the transmission path 13 via a space part 40, and a light receiving element 15 that receives a multiplexed optical signal multiplexed by the optical coupler 12.

### FIELD OF INVENTION

The present disclosure relates to a microphone that detects sound by using an optical fiber.

### BACKGROUND ART

In recent years, a microphone that detects a sound obtained by modulating an optical signal transmitted by an optical fiber based on a modulation degree of the optical signal has been put into practical use. For example, Patent Literature 1 describes an optical fiber interference type sensor that detects a sound obtained by modulating light propagating in a fiber by branching light emitted from a light source, propagating the light clockwise and counterclockwise in a loop-shaped fiber, and then demodulating the recombined light.

However, an acoustic impedance greatly differs between an environment in which sound to be detected is generated and a covering member constituting a peripheral surface of the optical fiber. Therefore, in the optical fiber interference type sensor disclosed in Patent Literature 1, a part of the sound is reflected by the peripheral surface of the fiber, and a sound pressure transmitted into the fiber decreases, and there is a possibility that a degree of change in a refractive index of the fiber decreases. As a result, there is a possibility that the sound cannot be accurately detected.
Patent Literature 1: JP 2005-241431 A

### SUMMARY OF THE INVENTION

The present disclosure has been made to solve such a problem, and an object of the present disclosure is to provide a microphone capable of accurately detecting a sound by using an optical fiber.

A microphone according to an aspect of the present disclosure includes a light source that outputs an optical signal, an optical coupler that demultiplexes and multiplexes the optical signal, a transmission path including an optical fiber that transmits a demultiplexed optical signal demultiplexed by the optical coupler to the optical coupler in mutually opposite directions, a sensor part that is connected to the transmission path and returns the demultiplexed optical signal to be transmitted by the transmission path to the transmission path via a space part, and a light receiving element that receives a multiplexed optical signal multiplexed by the optical coupler.

### BRIEF DESCRIPTION OF THE DRAWINGS

FIG. 1 is a diagram showing an overall configuration of a microphone according to a first embodiment.

FIG. 2 is a diagram showing a configuration of a sensor part according to a second embodiment.

FIG. 3 is a diagram showing a modified configuration of the sensor part according to the second embodiment.

FIG. 4 is a diagram showing a configuration of a sensor part according to a third embodiment.

FIG. 5 is a diagram showing an example of a configuration of a conventional Sagnac interference type microphone.

### DETAILED DESCRIPTION

### (Knowledge Underlying Present Disclosure)

In recent years, a microphone that detects sound obtained by modulating an optical signal transmitted by an optical fiber based on a modulation degree of an amplitude, frequency, or phase of the optical signal has been put into practical use as a measuring instrument and an acoustic emission (AE) sensor of sound generated in air and water.

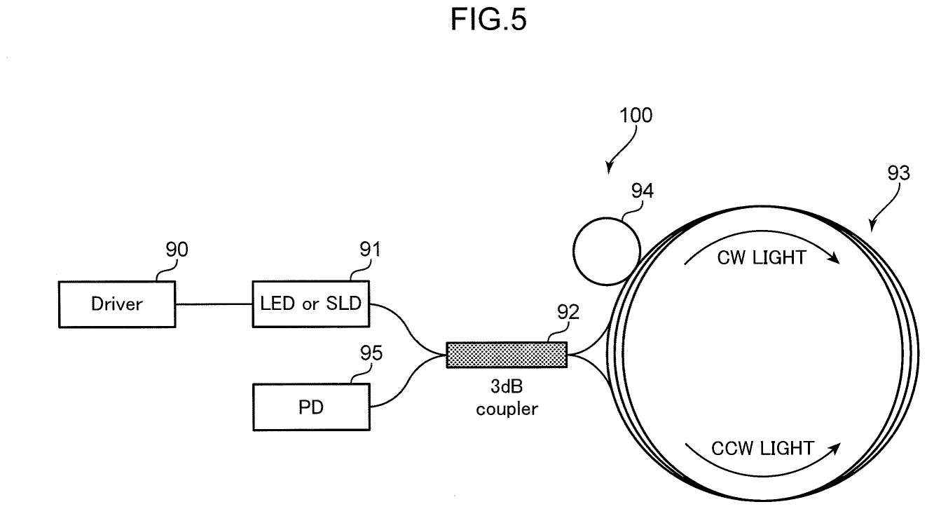

For example, as shown in FIG. 5, in a Sagnac interference type microphone 100 described in Patent Literature 1 and the like, a driver 90 causes a light source 91 such as a light emitting diode (LED) or a super luminescent diode (SLD) to emit an optical signal. An optical coupler 92 demultiplexes the optical signal emitted from the light source 91. The optical signal demultiplexed by the optical coupler 92 is transmitted in mutually opposite directions by a loop-shaped optical fiber 93.

A sensor part 94 that receives sound is configured at a position different from a midpoint of the optical fiber 93. The sensor part 94 is disposed in an environment (hereinafter, sound field) in which a sound to be detected is generated. Note that the sound field includes air, water, and the like. When sound is generated in the sound field, the sound is transmitted to the inside of the optical fiber 93 constituting the sensor part 94, and a refractive index of the optical fiber 93 changes by a sound pressure of the sound. As a result, the phase of the optical signal is modulated. Since the sensor part 94 is configured at a position different from the midpoint of the optical fiber 93, a timing at which an optical signal transmitted clockwise (hereinafter, CW light) and a timing at which an optical signal transmitted half-clockwise (hereinafter, CCW light) are modulated by the sensor part 94 are different.

The optical coupler 92 multiplexes the CW light and the CCW light modulated at different timings, and emits an optical signal indicating interference light of the CW light and the CCW light to a light receiving element 95 such as a photodiode. The light receiving element 95 converts the optical signal received from the optical coupler 92 into an electrical signal and outputs the electrical signal. As a result, the output signal of the light receiving element 95 is demodulated by a signal processing circuit or the like, and thus, the sound generated in the sensor part 94 can be detected.

However, an acoustic impedance greatly differs between the sound field in which the sound to be detected is generated and a covering member constituting a peripheral surface of the optical fiber 93. Therefore, in the conventional Sagnac interference type microphone 100, a part of the sound is reflected by the peripheral surface of the optical fiber 93, and a sound pressure transmitted into the optical fiber 93 decreases, and there is a possibility that a degree of change in the refractive index of the optical fiber 93 decreases. As a result, there is a possibility that the sound cannot be accurately detected.

Therefore, the present inventors have intensively studied a microphone capable of accurately detecting a sound by using an optical fiber, and has arrived at each aspect of the present disclosure described below.
(1) A microphone according to an aspect of the present disclosure includes a light source that outputs an optical signal, an optical coupler that demultiplexes and multiplexes the optical signal, a transmission path including an optical fiber that transmits a demultiplexed optical signal demultiplexed by the optical coupler to the optical coupler in mutually opposite directions, a sensor part that is connected to the transmission path and returns the demultiplexed optical signal to be transmitted by the transmission path to the transmission path via a space part, and a light receiving element that receives a multiplexed optical signal multiplexed by the optical coupler.

In this configuration, the demultiplexed optical signal demultiplexed by the optical coupler is returned to the transmission path via the space part by the sensor part in a midway of transmission to the optical coupler in mutually opposite directions by the optical fiber. Therefore, when sound is generated in the space part, the refractive index of a medium through which the demultiplexed optical signal passes can be directly changed by the sound without passing through a surface of the optical fiber. It is thus possible to clearly confirm a content of a change in a phase of the optical signal due to the sound generated in the space part from the multiplexed optical signal received by the light receiving element. As a result, the sound can be accurately detected.
(2) The microphone according to (1) may include a pair of lenses provided at both ends of the space part.

In this configuration, since the pair of lenses is provided at both ends of the space part, it is possible to reduce a degree of attenuation of the demultiplexed optical signal in the space part when the demultiplexed optical signal is returned to the transmission path via the space part.
(3) In the microphone according (1), the sensor part may include an optical waveguide that guides the demultiplexed optical signal, and the space part may be provided in a midway of the optical waveguide.

In this configuration, since the space part is provided in a midway of the optical waveguide included in the sensor part, the demultiplexed optical signal can be returned to the transmission path via the space part only by guiding the demultiplexed optical signal transmitted by the transmission path by the optical waveguide.
(4) In the microphone according to (3), the optical waveguide may include a plurality of branch paths, and the space part may be provided in a midway of the plurality of branch paths.

In this configuration, the optical waveguide includes the plurality of branch paths in which the space part is provided in the midway. Therefore, when the demultiplexed optical signal transmitted by the transmission path is guided by the optical waveguide, an optical path length through which the demultiplexed optical signal is transmitted in the space part can be increased. As a result, the degree of directly changing the refractive index of the medium through which the demultiplexed optical signal passes by the sound generated in the space part can be improved.
(5) In the microphone according to (3) or (4), the optical fiber may include a first optical fiber and a second optical fiber, the first optical fiber may be connected to one end of the optical waveguide, and the second optical fiber may be connected to another end of the optical waveguide.

In this configuration, since both ends of the optical waveguide are connected to the first optical fiber and the second optical fiber, the demultiplexed optical signal transmitted to the optical waveguide by the first optical fiber can be transmitted to the second optical fiber, and the demultiplexed optical signal transmitted to the optical waveguide by the second optical fiber can be transmitted to the first optical fiber. As a result, the demultiplexed optical signal transmitted to the sensor part by the transmission path including the optical fiber can be returned to the transmission path via the space part.
(6) In the microphone according to (1), the sensor part may include a pair of optical multiplexers/demultiplexers that demultiplexes the demultiplexed optical signal into an optical signal group of a plurality of wavelength components and multiplexes the optical signal group, and a plurality of demultiplexing transmission paths that transmits the optical signal group demultiplexed by one of the pair of optical multiplexers/demultiplexers to another one of the pair of optical multiplexers/demultiplexers via the space part.

In this configuration, when the demultiplexed optical signal is demultiplexed into the optical signal group of the plurality of wavelength components by one optical multiplexer/demultiplexer, the optical signal group is transmitted to the other optical multiplexer/demultiplexer via the space part by the plurality of demultiplexing transmission paths and multiplexed. Therefore, when sound is generated in the space part, the refractive index of the medium through which the optical signal of each wavelength component included in the optical signal group passes can be directly changed by the sound without passing through the surface of the optical fiber. As a result, an arrival direction of the sound generated in the space part can be estimated by confirming the timing at which the phase of the optical signal of each wavelength component included in the optical signal group changes from the multiplexed optical signal received by the light receiving element.
(7) In the microphone according to (6), each of the plurality of demultiplexing transmission paths may include the pair of lenses provided at the both ends of the space part.

In this configuration, since the pair of lenses is provided at both ends of the space part included in each demultiplexing transmission path, it is possible to reduce a degree of attenuation of each optical signal in the space part when the demultiplexed optical signal included in the optical signal group is returned to the transmission path via the space part by each demultiplexing transmission path.
(8) In the microphone according to (6) or (7), the optical fiber may include the first optical fiber and the second optical fiber, the first optical fiber may be connected to one of the pair of optical multiplexers/demultiplexers, and the second optical fiber may be connected to another one of the pair of optical multiplexers/demultiplexers.

This configuration makes it possible to demultiplex the demultiplexed optical signal transmitted to one optical multiplexer/demultiplexer by the first optical fiber into optical signal group of the plurality of wavelength components, transmit the optical signal group to the other optical multiplexer/demultiplexer by the plurality of demultiplexing transmission paths, multiplex the optical signal group, and then transmit the multiplexed optical signal to the second optical fiber. This configuration makes it possible to demultiplex the demultiplexed optical signal transmitted from the second optical fiber to the other optical multiplexer/demultiplexer into optical signal group of the plurality of wavelength components, transmit the optical signal group to the one optical multiplexer/demultiplexer by the plurality of demultiplexing transmission paths, multiplex the optical signal group, and then transmit the multiplexed optical signal to the first optical fiber. As a result, the demultiplexed optical signal transmitted to the sensor part by the transmission path including the optical fiber can be returned to the transmission path via the space part.
(9) In the microphone according to (2) or (7), the lens may include a collimator lens.

In this configuration, by using the collimator lens, the demultiplexed optical signal or each signal included in the optical signal group of the plurality of wavelength components can be transmitted as parallel light in the space part. It is therefore possible to suppress attenuation of the signal received by the light receiving element due to diffusion of these signals in the space part.

Note that all embodiments described below illustrate specific examples of the present disclosure. Numerical values, shapes, constituent elements, and the like of the embodiments below are merely examples, and do not intend to limit the present disclosure. A constituent element not described in an independent claim representing a highest concept among constituent elements in the embodiments below is described as an optional constituent element. In all the embodiments, content of each of the embodiments can be combined.

### First Embodiment

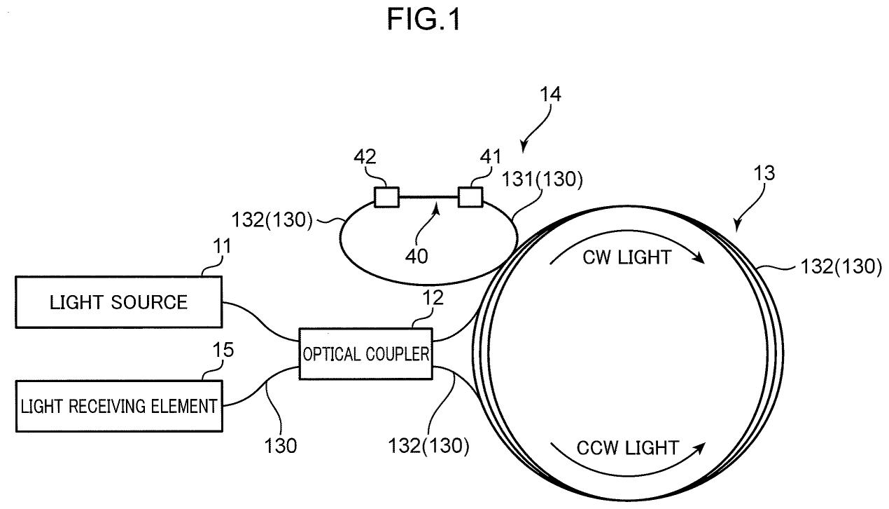

FIG. 1 is a diagram showing an overall configuration of a microphone according to a first embodiment. The microphone 1 includes a light source 11, an optical coupler 12, a transmission path 13, a sensor part 14, and a light receiving element 15.

The light source 11 is connected to a driving circuit (driver) (not shown), and outputs an optical signal corresponding to a driving signal output from the driving circuit. The light source 11 includes, for example, a super luminescent diode (SLD). However, the light source 11 is not limited to the SLD, and may include a light emitting diode (LED). Since the SLD outputs an optical signal having higher output intensity and higher coherence than the LED, the light source 11 preferably includes the SLD.

The optical coupler 12 is connected to the light source 11, the light receiving element 15, and the transmission path 13 by an optical fiber 130. The optical coupler 12 demultiplexes the optical signal input from the light source 11 into two optical signals (hereinafter, a demultiplexed optical signal), and outputs the two demultiplexed optical signals to the transmission path 13. The optical coupler 12 multiplexes the two demultiplexed optical signals input from the transmission path 13, and outputs an optical signal (hereinafter, a multiplexed optical signal) indicating interference light of two lights indicated by the two demultiplexed optical signals to the light receiving element 15.

The transmission path 13 includes the optical fiber 130, and transmits the two demultiplexed optical signals demultiplexed by the optical coupler 12 to the optical coupler 12 in mutually opposite directions. FIG. 1 shows an example in which one demultiplexed optical signal which is the “CW light” (hereinafter, a first demultiplexed optical signal) of the two demultiplexed optical signals is transmitted clockwise to the optical coupler 12, and the other demultiplexed optical signal which is the “CCW light” (hereinafter, a second demultiplexed optical signal) is transmitted counterclockwise to the optical coupler 12. The transmission path 13 is accommodated in a housing or the like so that an optical signal being transmitted in the optical fiber 130 is not modulated by surrounding sound.

Specifically, the optical fiber 130 includes an optical fiber that transmits an optical signal in a single mode. However, the optical fiber 130 is not limited to this configuration, and may include an optical fiber that transmits an optical signal in multiple modes. The optical fiber 130 is classified into a first optical fiber 131 and a second optical fiber 132. The first optical fiber 131 and the second optical fiber 132 have different lengths. One ends of the first optical fiber 131 and the second optical fiber 132 are connected to the optical coupler 12.

The sensor part 14 is connected to the transmission path 13 by the first optical fiber 131 and the second optical fiber 132, and returns the two demultiplexed optical signals transmitted by the transmission path 13 to the transmission path 13 via the space part 40. The sensor part 14 is disposed in an environment (hereinafter, sound field) in which a sound to be detected is generated. The sound field includes air, water, and the like.

Specifically, the other ends of the first optical fiber 131 and the second optical fiber 132 are arranged to face each other across the space part 40. A first lens 41 is provided at the other end of the first optical fiber 131, and a second lens 42 is provided at the other end of the second optical fiber 132. Thus, a pair of the first lens 41 and the second lens 42 is provided at both ends of the space part 40.

The first lens 41 converts the first demultiplexed optical signal transmitted to the other end of the first optical fiber 131 into a parallel optical signal and emits the parallel optical signal to the second lens 42 via the space part 40. The second lens 42 converts the second demultiplexed optical signal transmitted to the other end of the second optical fiber 132 into a parallel optical signal and emits the parallel optical signal to the first lens 41 via the space part 40. The first lens 41 condenses the second demultiplexed optical signal incident from the second lens 42 via the space part 40 and emits the second demultiplexed optical signal to the other end of the first optical fiber 131. On the other hand, the second lens 42 condenses the first demultiplexed optical signal incident from the first lens 41 via the space part 40 and emits the first demultiplexed optical signal to the other end of the second optical fiber 132.

The first lens 41 and the second lens 42 include, for example, a collimator lens.

However, one or more of the first lens 41 and the second lens 42 may include a lens that emits an optical signal as parallel light, such as a plano-convex lens. In these cases, the first demultiplexed optical signal and the second demultiplexed optical signal are diffused between the other end of the first optical fiber 131 and the other end of the second optical fiber 132. Therefore, attenuation of the first demultiplexed optical signal and the second demultiplexed optical signal transmitted to the optical coupler 12 can be suppressed.

In the above configuration, the first demultiplexed optical signal demultiplexed by the optical coupler 12 is transmitted to the first lens 41 of the sensor part 14 by the first optical fiber 131 of the transmission path 13. Thereafter, the first demultiplexed optical signal is emitted to the other end of the second optical fiber 132 of the transmission path 13 via the space part 40 by the pair of the first lens 41 and the second lens 42, and is transmitted to the optical coupler 12 by the second optical fiber 132.

On the other hand, the second demultiplexed optical signal demultiplexed by the optical coupler 12 is transmitted to the second lens 42 of the sensor part 14 by the second optical fiber 132 of the transmission path 13. Thereafter, the second demultiplexed optical signal is emitted to the other end of the first optical fiber 131 of the transmission path 13 via the space part 40 by the pair of the second lens 42 and the first lens 41, and is transmitted to the optical coupler 12 by the first optical fiber 131.

The optical coupler 12 multiplexes the first demultiplexed optical signal and the second demultiplexed optical signal transmitted from the transmission path 13, and outputs a multiplexed optical signal indicating interference light of two lights indicated by the first demultiplexed optical signal and the second demultiplexed optical signal to the light receiving element 15.

The light receiving element 15 receives the multiplexed optical signal output from the optical coupler 12, converts the received multiplexed optical signal into an electrical signal, and outputs the electrical signal. The light receiving element 15 includes, for example, a photodiode or the like.

In the microphone 1 having this configuration, the first demultiplexed optical signal and the second demultiplexed optical signal demultiplexed by the optical coupler 12 are transmitted to the optical coupler 12 in mutually opposite directions by the optical fiber 130. In a midway of the transmission, the first demultiplexed optical signal and the second demultiplexed optical signal are returned to the optical fiber 130 via the space part 40 by the sensor part 14. Therefore, when sound is generated in the space part 40, the refractive index of a medium through which the first demultiplexed optical signal and the second demultiplexed optical signal pass can be directly changed by the sound without passing through a surface of the optical fiber 130. It is thus possible to clearly confirm a content of a change in a phase of the optical signal due to the sound generated in the space part 40 from the multiplexed optical signal received by the light receiving element 15. As a result, the sound can be accurately detected.

### Second Embodiment

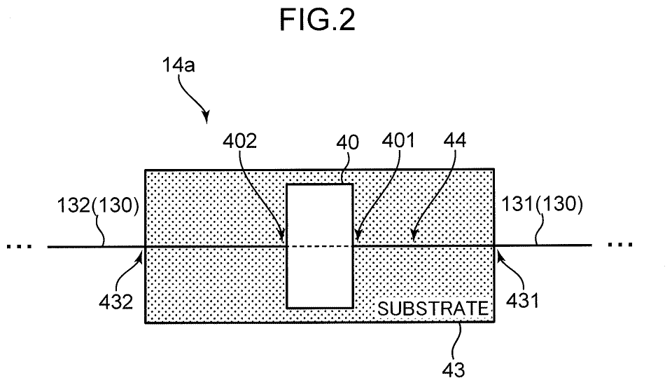

Hereinafter, a configuration of the microphone 1 according to a second embodiment of the present disclosure will be described. The microphone 1 according to the second embodiment is different from the first embodiment in the configuration of the sensor part 14 (FIG. 1). A sensor part 14a (FIG. 2) according to the second embodiment includes an optical waveguide 44 that guides a demultiplexed optical signal, and the space part 40 is provided in a midway of the optical waveguide 44.

FIG. 2 is a diagram showing a configuration of the sensor part 14a according to the second embodiment. Specifically, as shown in FIG. 2, the sensor part 14a includes a substrate 43 having the space part 40. The space part 40 is configured by cutting out a part of the substrate 43. The substrate 43 is provided with the optical waveguide 44 that guides an optical signal from one end 431 of the substrate 43 to the other end 432 of the substrate 43 via a first end 401 and a second end 402 facing each other in the space part 40. The other end of the first optical fiber 131 is connected to the one end 431 of the substrate 43, and the other end of the second optical fiber 132 is connected to the other end 432 of the substrate 43. That is, the other end of the first optical fiber 131 is connected to one end of the optical waveguide 44, and the other end of the second optical fiber 132 is connected to the other end of the optical waveguide 44.

In the sensor part 14a according to the second embodiment, the first demultiplexed optical signal and the second demultiplexed optical signal can be transmitted from the other end of the first optical fiber 131 to the other end of the second optical fiber 132 via the space part 40 by the optical waveguide 44 formed on the substrate 43. It is therefore possible to save time and effort for the arrangement described above.

Note that, in FIG. 2, the shape of the space part 40 is rectangular, but the shape of the space part 40 is not limited to this shape. For example, the shape of the space part 40 may be another shape such as an ellipse. In accordance with this case, the positions of the first end 401 and the second end 402 facing each other in the space part 40 through which the optical waveguide 44 passes may be changed.

In the example in FIG. 2, the optical waveguide 44 is formed such that both ends are located at ends facing each other in a longitudinal direction of the substrate 43a. However, the position is not limited to the above example, and both ends of the optical waveguide 44 may be located, for example, at ends facing each other in a lateral direction of the substrate 43a. Alternatively, one end of the optical waveguide 44 may be located at any of the ends facing each other in the lateral direction on the substrate 43a, and the other end of the optical waveguide 44 may be located at any of the ends facing each other in the longitudinal direction of the substrate 43a.

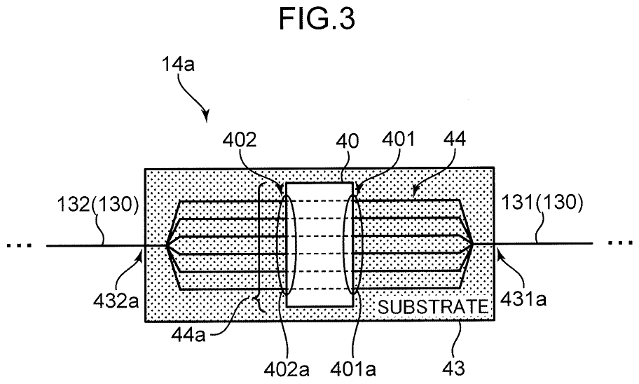

FIG. 3 is a diagram showing a modified configuration of the sensor part 14a according to the second embodiment. For example, as shown in FIG. 3, the first end 401 (FIG. 2) may include a plurality of first branch ends 401a, and the second end 402 (FIG. 2) may include a plurality of second branch ends 402a facing the plurality of first branch ends 401a. Thus, the optical waveguide 44 (FIG. 2) may include a plurality of branch optical waveguides 44a (branch paths).

FIG. 3 shows an example in which the optical waveguide 44 (FIG. 2) includes six branch optical waveguides 44a. That is, each of the six branch optical waveguides 44a is formed to guide an optical signal from one end 431a of the substrate 43a to the other end 432a of the substrate 43a via the first branch end 401a and the second branch end 402a facing each other on the space part 40.

In this configuration, an optical path length through which the first demultiplexed optical signal and the second demultiplexed optical signal are transmitted in the space part 40 is increased as compared with the configuration of the sensor part 14a shown in FIG. 2. Therefore, the degree of directly changing the refractive index of the medium through which the first demultiplexed optical signal and the second demultiplexed optical signal pass by the sound generated in the space part 40 can be improved.

### Third Embodiment

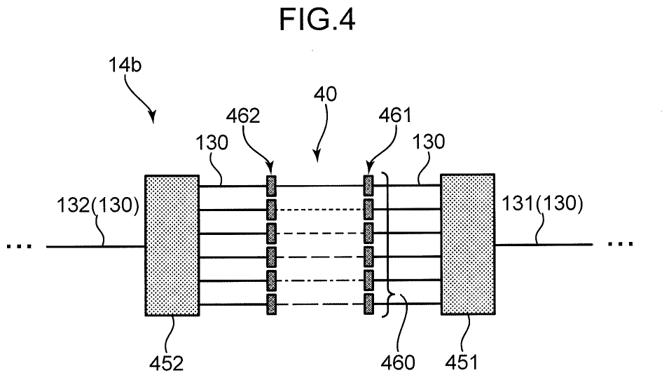

Hereinafter, a configuration of the microphone 1 according to a third embodiment of the present disclosure will be described. The microphone 1 according to the third embodiment is different from the microphone 1 according to the first embodiment and the microphone 1 according to the second embodiment in the configuration of the sensor part 14 (FIGS. 1, 2, and 3). FIG. 4 is a diagram showing a configuration of a sensor part 14b according to the third embodiment.

As shown in FIG. 4, the sensor part 14b (FIG. 4) according to the third embodiment includes a pair of first optical multiplexer/demultiplexer 451 and second optical multiplexer/demultiplexer 452 facing each other across the space part 40, and a plurality of demultiplexing transmission paths 460.

The other end of the first optical fiber 131 is connected to the first optical multiplexer/demultiplexer 451. The first optical multiplexer/demultiplexer 451 demultiplexes the first demultiplexed optical signal transmitted to the other end of the first optical fiber 131 into optical signal groups of a plurality of wavelength components different from each other. The other end of the second optical fiber 132 is connected to the second optical multiplexer/demultiplexer 452. The second optical multiplexer/demultiplexer 452 demultiplexes the second demultiplexed optical signal transmitted to the other end of the second optical fiber 132 into an optical signal group of a plurality of wavelength components which is the same as the plurality of wavelength components of the first optical multiplexer/demultiplexer 451.

The plurality of demultiplexing transmission paths 460 transmits the optical signal group demultiplexed by one of the first optical multiplexer/demultiplexer 451 or the second optical multiplexer/demultiplexer 452 to the other one of the first optical multiplexer/demultiplexer 451 or the second optical multiplexer/demultiplexer 452 via the space part 40. That is, the plurality of demultiplexing transmission paths 460 transmits the optical signal group demultiplexed by the first optical multiplexer/demultiplexer 451 to the second optical multiplexer/demultiplexer 452 via the space part 40, and transmits the optical signal group demultiplexed by the second optical multiplexer/demultiplexer 452 to the first optical multiplexer/demultiplexer 451 via the space part 40.

Specifically, each of the plurality of demultiplexing transmission paths 460 includes a pair of third lenses 461 and fourth lenses 462 provided at both ends of the space part 40.

The third lens 461 and the fourth lens 462 are disposed so as to face each other across the space part 40. The third lens 461 is connected to the first optical multiplexer/demultiplexer 451 by the optical fiber 130. The third lens 461 converts the optical signal of one wavelength component demultiplexed by the first optical multiplexer/demultiplexer 451 into a parallel optical signal and emits the parallel optical signal to the fourth lens 462 via the space part 40. The fourth lens 462 is connected to the second optical multiplexer/demultiplexer 452 by the optical fiber 130. The fourth lens 462 converts the optical signal of one wavelength component demultiplexed by the second optical multiplexer/demultiplexer 452 into a parallel optical signal and emits the parallel optical signal to the third lens 461 via the space part 40.

The third lens 461 condenses the optical signal incident from the fourth lens 462 through the space part 40, and transmits the condensed optical signal to the first optical multiplexer/demultiplexer 451 by the optical fiber 130. The fourth lens 462 condenses the optical signal incident from the third lens 461 via the space part 40, and transmits the condensed optical signal to the second optical multiplexer/demultiplexer 452 by the optical fiber 130.

The third lens 461 and the fourth lens 462 include, for example, a collimator lens. However, one or more of the third lens 461 or the fourth lens 462 may include a lens such as a plano-convex lens that converts an optical signal into a parallel optical signal and emits the parallel optical signal. In these cases, in the space part 40, the optical signal group of the plurality of wavelength components demultiplexed by one of the first optical multiplexer/demultiplexer 451 or the second optical multiplexer/demultiplexer 452 is diffused. It is therefore possible to suppress attenuation of the optical signal group transmitted to the other one of the first optical multiplexer/demultiplexer 451 or the second optical multiplexer/demultiplexer 452.

Furthermore, when the optical signal group of the plurality of wavelength components demultiplexed by the second optical multiplexer/demultiplexer 452 is transmitted via the fourth lens 462, the space part 40, and the third lens 461, the first optical multiplexer/demultiplexer 451 multiplexes the optical signal group and outputs the multiplexed optical signal to the other end of the first optical fiber 131. Similarly, furthermore, when the optical signal group of the plurality of wavelength components demultiplexed by the first optical multiplexer/demultiplexer 451 is further transmitted via the third lens 461, the space part 40, and the fourth lens 462, the second optical multiplexer/demultiplexer 452 multiplexes the optical signal group and outputs the multiplexed optical signal to the other end of the second optical fiber 132.

In this configuration, the refractive index of the medium through which the optical signal of each wavelength component transmitted in the space part 40 passes is directly changed without passing through the surface of the optical fiber 130 by the sound generated in the space part 40. As a result, an arrival direction of the sound generated in the space part 40 can be estimated by confirming the timing at which the phase of the optical signal of each wavelength component changes from the multiplexed optical signal received by the light receiving element 15.

Since the microphone of the present disclosure can accurately detect a sound by using an optical fiber, the microphone is useful as a measuring instrument and an AE sensor of sound generated in air and water.

1. A microphone comprising:
a light source that outputs an optical signal;
an optical coupler that demultiplexes and multiplexes the optical signal;
a transmission path including an optical fiber that transmits a demultiplexed optical signal demultiplexed by the optical coupler to the optical coupler in mutually opposite directions;
a sensor part that is connected to the transmission path and returns the demultiplexed optical signal to be transmitted by the transmission path to the transmission path via a space part; and
a light receiving element that receives a multiplexed optical signal multiplexed by the optical coupler.

2. The microphone according to claim 1, further comprising
a pair of lenses provided at both ends of the space part.

3. The microphone according to claim 1, wherein
the sensor part includes an optical waveguide that guides the demultiplexed optical signal, and
the space part is provided in a midway of the optical waveguide.

4. The microphone according to claim 3, wherein
the optical waveguide includes a plurality of branch paths, and
the space part is provided in a midway of the plurality of branch paths.

5. The microphone according to claim 3, wherein
the optical fiber includes a first optical fiber and a second optical fiber,
the first optical fiber is connected to one end of the optical waveguide, and
the second optical fiber is connected to another end of the optical waveguide.

6. The microphone according to claim 1, wherein
the sensor part includes
a pair of optical multiplexers/demultiplexers that demultiplexes the demultiplexed optical signal into an optical signal group of a plurality of wavelength components and multiplexes the optical signal group, and
a plurality of demultiplexing transmission paths that transmits the optical signal group demultiplexed by one of the pair of optical multiplexers/demultiplexers to another one of the pair of optical multiplexers/demultiplexers via the space part.

7. The microphone according to claim 6, wherein
each of the plurality of demultiplexing transmission paths includes the pair of lenses provided at the both ends of the space part.

8. The microphone according to claim 6, wherein
the optical fiber includes a first optical fiber and a second optical fiber,
the first optical fiber is connected to one of the pair of optical multiplexers/demultiplexers, and
the second optical fiber is connected to another one of the pair of optical multiplexers/demultiplexers.

9. The microphone according to claim 2, wherein
the lens includes a collimator lens.
